(19) United States
(12) Patent Application Publication
(10) Pub. No.: US 2026/0335170 A1
(43) Pub. Date: Oct. 29, 2026

(54) SHOCK-ABSORBING ROLLATOR

(71) Applicant: Zhongshan QUNN Medical Equipment Co., Ltd., Zhongshan (CN)

(72) Inventors: Weiguo Liu, Zhongshan (CN); Minghai LIU, Zhongshan (CN)

(21) Appl. No.: 19/356,119

(22) Filed: Oct. 11, 2025

(30) Foreign Application Priority Data
Apr. 28, 2025 (CN) 2025208294312

(51) Int. Cl. A61H 3/04

(52) U.S. Cl. CPC A61H 3/04; A61H 2201/0161; A61H 2201/0165; A61H 2201/1633; A61H 2201/1635

(57) ABSTRACT

The present disclosure discloses a shock-absorbing rollator, including: a foldable seat assembly; armrest assemblies, respectively provided at both sides of the seat assembly, and each of which at least including a crossbar at the bottom and an armrest bar provided on the crossbar; connecting rods, each having an upper end connected to a middle-rear position of the respective crossbar, and a lower end connected to a respective rear wheel; and shock-absorbing systems, each having an upper end connected to a rear end of the respective crossbar, and a lower end connected to a middle position of the respective connecting rod. The shock-absorbing rollator has better shock-absorbing and buffering performance and is beneficial to enhancing the riding experience of a passenger.

### TECHNICAL FIELD

The present disclosure relates to the technical field of rollators, and in particular, to a shock-absorbing rollator.

### BACKGROUND

In related technologies, rollators are widely used in households, hospitals, and rehabilitation institutions. These rollators assist individuals with mobility difficulties, the elderly and frail, and those with lower limb disabilities to walk or undergo rehabilitation training.

However, the existing rollators has poor shock-absorbing and buffering performance, especially when the rollator traverses uneven road surfaces, a passenger experiences significantly jolting, leading to a poor user experience. Moreover, the jolting has a certain impact on the internal structure of the rollator, affecting the connections between some parts, and thus affecting the usage stability and reliability of the rollator and reducing its service life.

Therefore, it is necessary to improve the existing technology.

### SUMMARY

The present disclosure aims to solve at least one of the problems in the existing related technologies to a certain extent. Therefore, the present disclosure proposes a shock-absorbing rollator, which has better shock-absorbing and buffering performance and is beneficial to enhancing the riding experience of a passenger.

The above-mentioned objective is achieved through the following technical solution:
A shock-absorbing rollator, including:
   a foldable seat assembly;
   armrest assemblies, respectively provided at both sides of the seat assembly, and each of which at least including a crossbar at the bottom and an armrest bar provided on the crossbar;
   connecting rods, each having an upper end connected to a middle-rear position of the respective crossbar, and a lower end connected to a respective rear wheel; and
   shock-absorbing systems, each having an upper end connected to a rear end of the respective crossbar, and a lower end connected to a middle position of the respective connecting rod.

In some embodiments, the crossbars extend horizontally in front-rear directions of the seat assembly, a lower end of each armrest bar is connected to a middle or front-middle position of the respective crossbar, and the armrest bars are inclined rearward in a vertical direction of the seat assembly.

In some embodiments, the connecting rods are arc-shaped, the lower end of each connecting rod is located below a rear side of the respective crossbar, and a front wheel is arranged at a front end of each crossbar.

In some embodiments, the shock-absorbing system is inclined downward and rearward relative to the respective crossbar.

In some embodiments, each of the shock-absorbing systems includes a shock-absorbing rod and a shock-absorbing spring, where a first blocking portion is arranged at an upper end of the shock-absorbing rod, a second blocking portion is arranged at at a lower end of the shock-absorbing rod, the shock-absorbing spring is sleeved outside the shock-absorbing rod and compressed and confined between the first blocking portion and the second blocking portion, a first connecting portion is formed at an upper side of the first blocking portion on the shock-absorbing rod for connecting to the rear end of the crossbar, and a second connecting portion is formed at a lower side of the second blocking portion on the shock-absorbing rod for connecting to the connecting rod.

In some embodiments, a first connecting member is arranged at the rear end of the crossbar, a second connecting member is arranged on the connecting rod, the first connecting portion of the shock-absorbing system is connected to the first connecting member, and the second connecting portion is connected to the second connecting member.

In some embodiments, the first connecting member at least includes a first base plate, and a first left side plate and a first right side plate that are respectively provided at both sides of the first base plate, where a first connecting groove is formed among the first base plate, the first left side plate and the first right side plate, the first base plate is fixed to the rear end of the crossbar, and the first connecting portion of the shock-absorbing system is inserted into the first connecting groove and connected to the first left side plate and the first right side plate; and

the second connecting member at least includes a second base plate, and a second left side plate and a second right side plate that are respectively provided at both sides of the second base plate, where a second connecting groove is formed among the second base plate, the second left side plate and the second right side plate, the second base plate is fixed to the connecting rod, and the second connecting portion of the shock-absorbing system is inserted into the second connecting groove and connected to the second left side plate and the second right side plate.

In some embodiments, a third connecting member is arranged at the middle-rear position of the crossbar, and the upper end of the connecting rod is connected to the third connecting member.

In some embodiments, the third connecting member at least includes a third base plate, and a third left side plate and a third right side plate that are respectively provided at both sides of the third base plate, where a third connecting groove is formed among the third base plate, the third left side plate and the third right side plate, the crossbar is inserted into the third connecting groove and connected to the third left side plate and the third right side plate, and the upper end of the connecting rod is connected to the bottom of the third base plate.

In some embodiments, a first gasket is provided between the third left side plate and the crossbar, a second gasket is provided between the third right side plate and the crossbar, and the first gasket and the second gasket are connected together by a connecting shaft.

Compared with the prior art, the present disclosure at least has the following beneficial effects:

1. The shock-absorbing rollator provided by the present disclosure has better shock-absorbing and buffering performance and is beneficial to enhancing the riding experience of a passenger.

### BRIEF DESCRIPTION OF THE DRAWINGS

FIG. 1 is a first schematic perspective view of a shock-absorbing rollator in an embodiment.

FIG. 2 is a second schematic perspective view of a shock-absorbing rollator in an embodiment.

FIG. 3 is a partial enlarged view of part A in FIG. 2.

FIG. 4 is a partial exploded view of a shock-absorbing rollator in an embodiment.

FIG. 5 is a partial enlarged view of part B in FIG. 4.

FIG. 6 is schematic perspective view of a shock-absorbing system in an embodiment.

### DETAILED DESCRIPTION OF THE EMBODIMENTS

The present disclosure is described by means of the following embodiments, but the present disclosure is not limited by these embodiments. Modifications made to the specific implementations of the present disclosure or equivalent replacements made to some technical features without departing from the spirit of the solutions of the present disclosure shall be included in the scope of the technical solutions claimed by the present disclosure.

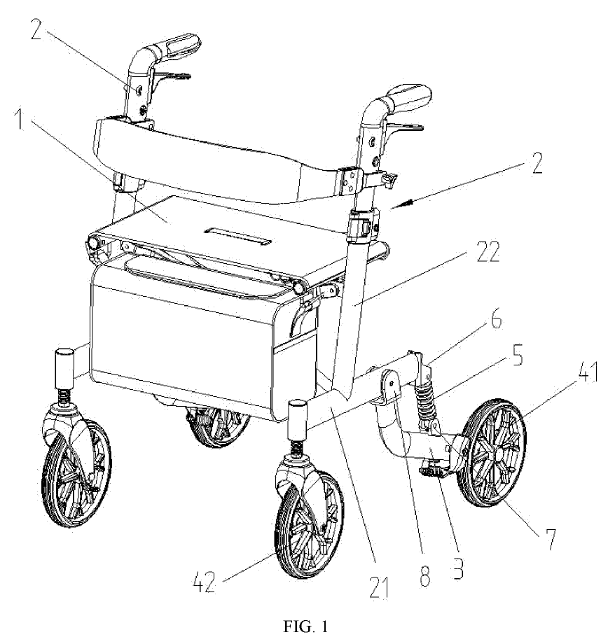

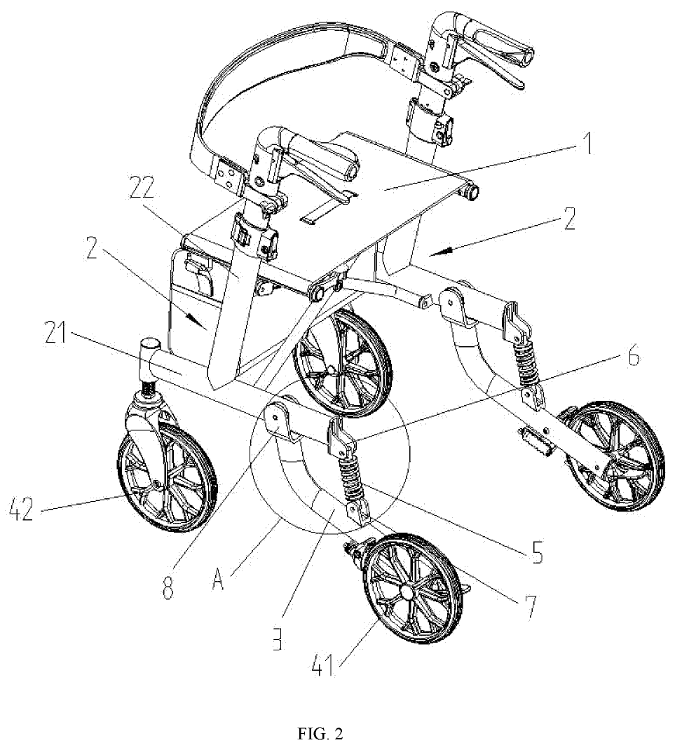

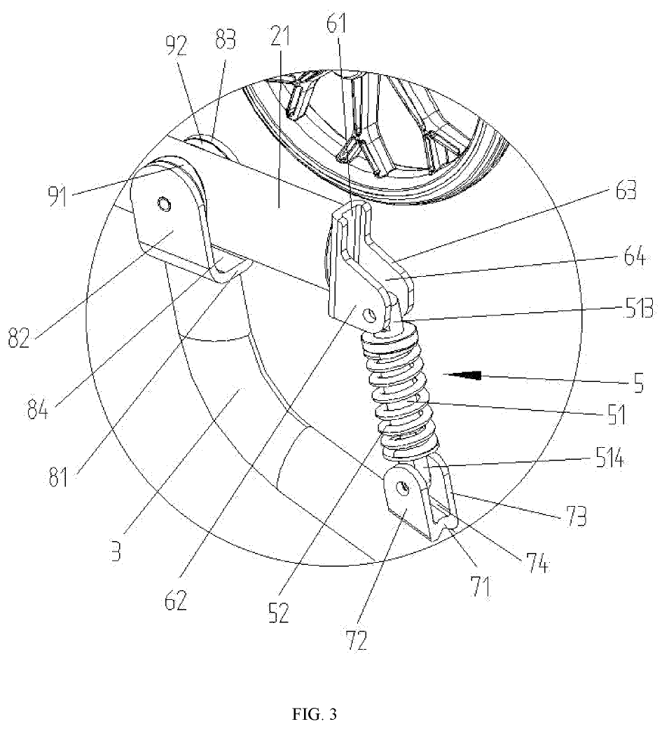

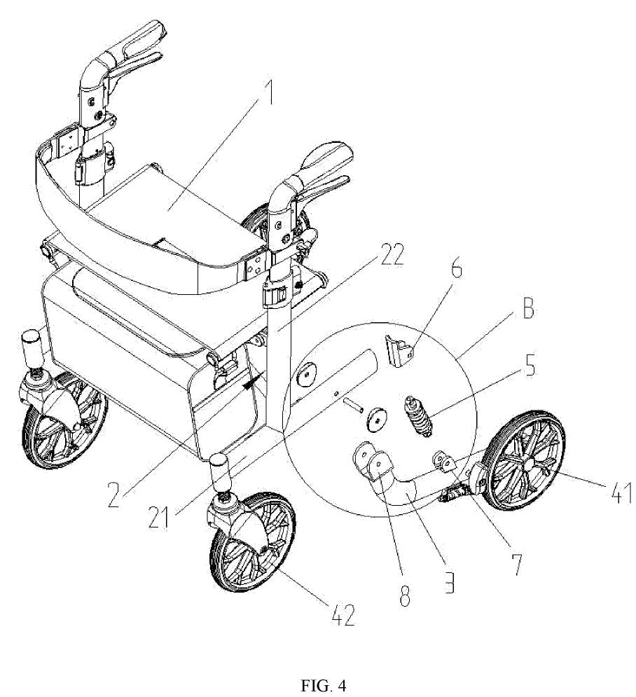

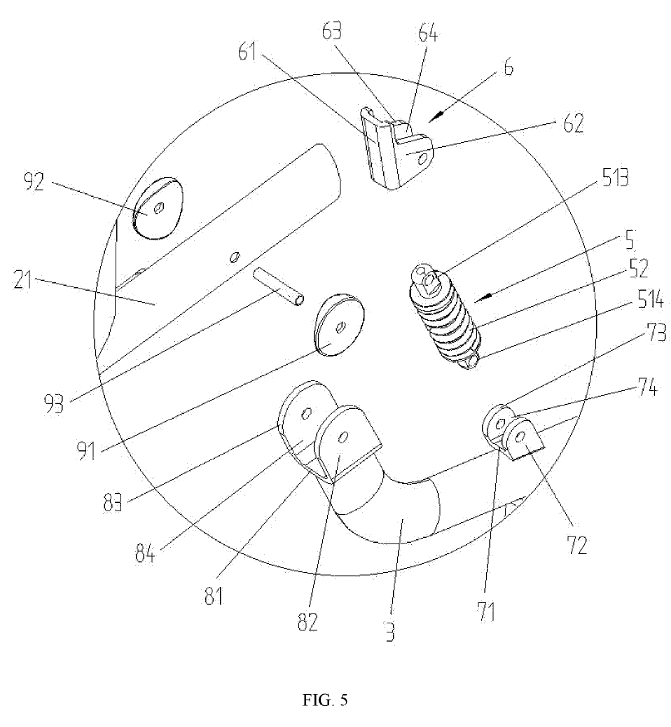

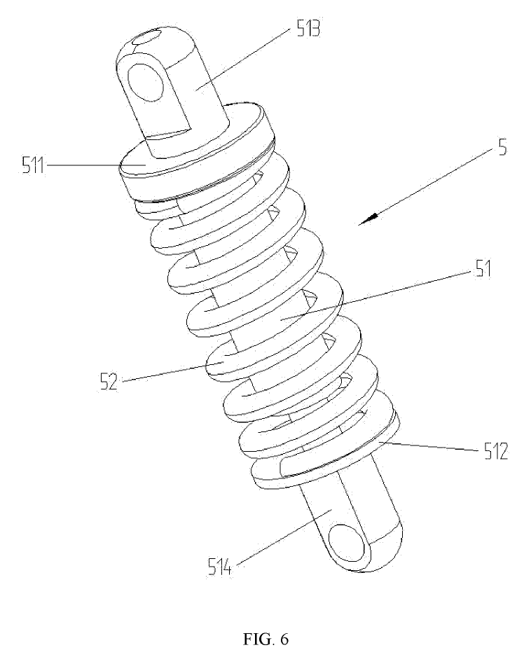

Embodiment 1: as shown in FIGS. 1-6, this embodiment provides a shock-absorbing rollator, including:
a foldable seat assembly 1;
armrest assemblies 2, respectively provided at both sides of the seat assembly 1 and each of which at least including a crossbar 21 at the bottom and an armrest bar 22 provided on the crossbar 21;
connecting rods 3, each having an upper end connected to a middle-rear position of the respective crossbar 21, and a lower end connected to a respective rear wheel 41; and shock-absorbing systems 5, each having an upper end connected to a rear end of the respective crossbar 21, and a lower end connected to a middle position of the respective connecting rod 3.

The shock-absorbing rollator provided by this embodiment has better shock-absorbing and buffering performance and is beneficial to enhancing the riding experience of a passenger.

Specifically, through the addition of the shock-absorbing systems 5, when the rollator traverses uneven road surfaces, the shock-absorbing systems 5 can reduce jolts and vibrations transmitted from the rear wheels 41 to the armrest assemblies 2 and the seat assembly 1, thereby enhancing the riding experience of the passenger. Moreover, by reducing the jolts and vibrations of the armrest assemblies 2 and the seat assembly 1, the impact of the jolts and vibrations on the internal structure of the rollator is further reduced, and the influence on the connection between parts can also be reduced, which is beneficial to improving the usage stability and reliability of the rollator and prolonging its service life.

In this embodiment, the crossbars 21 extend horizontally in the front-rear direction of the seat assembly 1, and a lower end of each armrest bar 22 is connected to a middle or front-middle position of the respective crossbar 21. The armrest assemblies 2 are roughly in the shapes of inverted T, which have simple structures, and high overall stability and reliability. Moreover, the armrest bars 22 are inclined rearward in the vertical direction of the seat assembly 1. By the inclined armrest bars 22, it is convenient for a user to push the rollator.

Further, the connecting rods 3 are arc-shaped, a lower end of each connecting rod 3 is located below a rear side of the respective crossbar 21, and a front wheel 42 is arranged at a front end of each crossbar 21. The structure is simple and is reasonable in arrangement, so that the jolts and vibrations transmitted from the rear wheels 41 to the armrest assemblies 2 and the seat assembly 1 can be further reduced, thereby improving the shock-absorbing and buffering performance of the whole rollator.

Preferably, the shock-absorbing system 5 is inclined downward and rearward relative to the respective crossbar 21. The structure is simple and reasonable in arrangement, so that the shock-absorbing and buffering performance of the whole rollator can be improved to a certain extent, and the jolts and vibrations transmitted from the rear wheels 41 to the armrest assemblies 2 and the seat assembly 1 can be reduced.

In this embodiment, each of the shock-absorbing systems 5 includes a shock-absorbing rod 51 and a shock-absorbing spring 52, where a first blocking portion 511 is arranged at an upper end of the shock-absorbing rod 51, a second blocking portion 512 is arranged at a lower end of the shock-absorbing rod 51, the shock-absorbing spring 52 is sleeved outside the shock-absorbing rod 51 and compressed and confined between the first blocking portion 511 and the second blocking portion 512, a first connecting portion 513 is formed at an upper side of the first blocking portion 511 on the shock-absorbing rod 51 for connecting to the rear end of the crossbar 21, and a second connecting portion 514 is formed at a lower side of the second blocking portion 512 on the shock-absorbing bar 51 for connecting to the connecting rod 3. The shock-absorbing systems 5 are simple in overall structures and reasonable in design, and have better shock-absorbing and buffering performance, so that the jolts and vibrations transmitted from the rear wheels 41 to the armrest assemblies 2 and the seat assembly 1 can be effectively reduced.

Further, a first connecting member 6 is arranged at the rear end of the crossbar 21, a second connecting member 7 is arranged on the connection rod 3, the first connecting portion 513 of the shock-absorbing system 5 is connected to the first connecting member 6, and the second connecting portion 514 is connected to the second connecting member 7. The structure is simple and reasonable in design, so that the convenience of connections between the shock-absorbing system 5 and the crossbar 21 as well as the connecting rod 3 can be improved.

Furthermore, the first connecting member 6 at least includes a first base plate 61, and a first left side plate 62 and a first right side plate 63 that are respectively provided at both sides of the first base plate 61, where a first connecting groove 64 is formed among the first base plate 61, the first left side plate 62 and the first right side plate 63, the first base plate 61 is fixed to the rear end of the crossbar 21, and the first connecting portion 513 of the shock-absorbing system 5 is inserted into the first connecting groove 64 and connected to the first left side plate 62 and the first right side plate 63. The structure is simple, the connection between the shock-absorbing system 5 and the crossbar 21 is simple, and the stability and reliability are higher.

The second connecting member 7 at least includes a second base plate 71, and a second left side plate 72 and a second right side plate 73 that are respectively provided at both sides of the second base plate 71, where a second connecting groove 74 is formed among the second base plate 71, the second left side plate 72 and the second right side plate 73, the second base plate 71 is fixed to the connecting rod 3, and the second connecting portion 514 of the shock-absorbing system 5 is inserted into the second connecting groove 74 and connected to the second left side plate 72 and the second right side plate 73. The structure is simple, the connection between the shock-absorbing system 5 and the connecting rod 3 is simple, and the stability and reliability are higher.

In this embodiment, a third connecting member 8 is arranged at the middle-rear position of the crossbar 21, and the upper end of the connecting rod 3 is connected to the third connecting member 8. The structure is simple and reasonable in design, so that the convenience of connection between the connecting rod 3 and the crossbar 21 can be improved.

Further, the third connecting member 8 at least includes a third base plate 81, and a third left side plate 82 and a third right side plate 83 that respectively provided at both sides of the third base plate 81, where a third connecting groove 84 is formed among the third base plate 81, the third left side plate 82 and the third right side plate 83, the crossbar 21 is inserted into the third connecting groove 84 and connected to the third left side plate 82 and the third right side plate 83, and the upper end of the connecting rod 3 is connected to the bottom of the third base plate 81. The structure is simple, the connection between the connecting rod 3 and the crossbar 21 is simple, and the stability and reliability are higher.

Furthermore, a first gasket 91 is provided between the third left side plate 82 and the crossbar 21, a second gasket 92 is provided between the third right side plate 83 and the crossbar 21, and the first gasket 91 and the second gasket 92 are connected together by a connecting shaft 93. The structure is simple, so that the stability and reliability of the connection between the connecting rod 3 and the crossbar 21 can be further improved.

The above descriptions are only some embodiments of the present disclosure. Those having ordinary skill in the art can make several modifications and improvements without departing from the inventive concept of the present disclosure, and these modifications and improvements all fall within the scope of protection of the present disclosure.

What is claimed is:

1. A shock-absorbing rollator, comprising:
a foldable seat assembly (1);
armrest assemblies (2), respectively provided at both sides of the seat assembly (1), and each of which at least comprising a crossbar (21) at the bottom and an armrest bar (22) provided on the crossbar (21);
connecting rods (3), each having an upper end connected to a middle-rear position of the respective crossbar (21), and a lower end connected to a respective rear wheel (41); and
shock-absorbing systems (5), each having an upper end connected to a rear end of the respective crossbar (21), and a lower end connected to a middle position of the respective connecting rod (3).

2. The shock-absorbing rollator according to claim 1, wherein the crossbars (21) extend horizontally in a front-rear direction of the seat assembly (1), a lower end of each armrest bar (22) is connected to a middle or front-middle position of the respective crossbar (21), and the armrest bars (22) are inclined rearward in a vertical direction of the seat assembly (1).

3. The shock-absorbing rollator according to claim 1, wherein the connecting rods (3) are arc-shaped, the lower end of each connecting rod (3) is located below a rear side of the respective crossbar (21), and a front wheel (42) is arranged at a front end of each crossbar (21).

4. The shock-absorbing rollator according to claim 1, wherein the shock-absorbing system (5) is inclined downward and rearward relative to the respective crossbar (21).

5. The shock-absorbing rollator according to claim 4, wherein each of the shock-absorbing systems (5) comprises a shock-absorbing rod (51) and a shock-absorbing spring (52), a first blocking portion (511) is arranged at an upper end of the shock-absorbing rod (51), a second blocking portion (512) is arranged at a lower end of the shock-absorbing rod (51), the shock-absorbing spring (52) is sleeved outside the shock-absorbing rod (51) and compressed and confined between the first blocking portion (511) and the second blocking portion (512), a first connecting portion (513) is formed at an upper side of the first blocking portion (511) on the shock-absorbing rod (51) for connecting to the rear end of the crossbar (21), and a second connecting portion (514) is formed at a lower side of the second blocking portion (512) on the shock-absorbing rod (51) for connecting to the connecting rod (3).

6. The shock-absorbing rollator according to claim 5, wherein a first connecting member (6) is arranged at the rear end of the crossbar (21), a second connecting member (7) is arranged on the connecting rod (3), the first connecting portion (513) of the shock-absorbing system (5) is connected to the first connecting member (6), and the second connecting portion (514) is connected to the second connecting member (7).

7. The shock-absorbing rollator according to claim 6, wherein the first connecting member (6) at least comprises a first base plate (61), and a first left side plate (62) and a first right side plate (63) that are respectively provided at both sides of the first base plate (61), a first connecting groove (64) is formed among the first base plate (61), the first left side plate (62) and the first right side plate (63), the first base plate (61) is fixed to the rear end of the crossbar (21), and the first connecting portion (513) of the shock-absorbing system (5) is inserted into the first connecting groove (64) and connected to the first left side plate (62) and the first right side plate (63); and
the second connecting member (7) at least comprises a second base plate (71), and a second left side plate (72) and a second right side plate (73) that are respectively provided at both sides of the second base plate (71), a second connecting groove (74) is formed among the second base plate (71), the second left side plate (72) and the second right side plate (73), the second base plate (71) is fixed to the connecting rod (3), and the second connecting portion (514) of the shock-absorbing system (5) is inserted into the second connecting groove (74) and connected to the second left side plate (72) and the second right side plate (73).

8. The shock-absorbing rollator according to claim 1, wherein a third connecting member (8) is arranged at the middle-rear position of the crossbar (21), and the upper end of the connecting rod (3) is connected to the third connecting member (8).

9. The shock-absorbing rollator according to claim 8, wherein the third connecting member (8) at least comprises a third base plate (81), and a third left side plate (82) and a third right side plate (83) that are respectively provided at both sides of the third base plate (81), a third connecting groove (84) is formed among the third base plate (81), the third left side plate (82) and the third right side plate (83), the crossbar (21) is inserted into the third connecting groove (84) and connected to the third left side plate (82) and the third right side plate (83), and the upper end of the connecting rod (3) is connected to the bottom of the third base plate (81).

10. The shock-absorbing rollator according to claim 9, wherein a first gasket (91) is provided between the third left side plate (82) and the crossbar (21), a second gasket (92) is provided between the third right side plate (83) and the crossbar (21), and the first gasket (91) and the second gasket (92) are connected together by a connecting shaft (93).
